(19) United States
(12) Patent Application Publication
(10) Pub. No.: US 2025/0286601 A1
(43) Pub. Date: Sep. 11, 2025

(54) BEAM REPORTING BASED ON A PREDICTED USER EQUIPMENT BEAM DWELLING TIME

(71) Applicant: Apple Inc., Cupertino, CA (US)

(72) Inventors: Yushu Zhang, Beijing (CN); Chunxuan Ye, San Diego, CA (US); Dawei Zhang, Saratoga, CA (US); Haitong Sun, Saratoga, CA (US); Hong He, San Jose, CA (US); Huaning Niu, San Jose, CA (US); Oghenekome Oteri, San Diego, CA (US); Wei Zeng, Saratoga, CA (US); Weidong Yang, San Diego, CA (US)

(73) Assignee: Apple Inc., Cupertino, CA (US)

(21) Appl. No.: 18/858,702

(22) PCT Filed: Apr. 4, 2023
(86) PCT No.: PCT/US2023/017407

§ 371 Date: Oct. 21, 2024

Related U.S. Application Data
(60) Provisional application No. 63/336,204, filed on Apr. 28, 2022.

(51) Int. Cl. H04B 7/06; H04W 16/28; H04W 24/10

(52) U.S. Cl. CPC H04B 7/06952; H04W 16/28; H04W 24/10

(57) ABSTRACT

The present application relates to devices and components including apparatus, systems, and methods to perform beam measurements and beam reporting. In an example, a beam measurement may exist and can be used to generate a predicted dwelling time of a UE in a beam of a base station. The dwelling time represents a time duration during which the beam is expected to have the best beam quality for the UE among the beams of the base station. Given the predicted dwelling time, the base station can send a reference signal to the UE, or the UE can perform a measurement on the reference signal and/or send information about this measurement to the base station. This information can be sent as a beam report.

### CROSS REFERENCE TO RELATED APPLICATION

This application claims priority to U.S. Provisional Application No. 63/336,204, filed Apr. 28, 2022. The contents of this application is hereby incorporated by reference in its entirety for all purposes.

### BACKGROUND

Cellular communications can be defined in various standards to enable communications between a user equipment and a cellular network. For example, Fifth Generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of beam measurements, in accordance with some embodiments.

FIG. 3 illustrates an example of using an artificial intelligence model to generate a prediction of a dwelling time, in accordance with some embodiments.

FIG. 4 illustrates an example of an operational flow/algorithmic structure for a user equipment (UE) performing beam reporting, in accordance with some embodiments.

FIG. 5 illustrates an example of an operational flow/algorithmic structure for a base station configuring a UE to perform beam reporting, in accordance with some embodiments, in accordance with some embodiments.

FIG. 6 illustrates an example of a sequence diagram that involves a base station and a UE supporting beam management, in accordance with some embodiments.

FIG. 7 illustrates another example of a sequence diagram that involves a base station and a UE supporting beam management, in accordance with some embodiments.

FIG. 8 illustrates yet another example of a sequence diagram that involves a base station and a UE supporting beam management, in accordance with some embodiments.

FIG. 9 illustrates an example of receive components, in accordance with some embodiments.

FIG. 10 illustrates an example of a UE, in accordance with some embodiments.

FIG. 11 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can communicate with a base station to access a cellular network (e.g., a 5G cellular network). The communication can be based on beams emitted by the base station, whereby the beam having the best quality (e.g., based on reference signal measurements) is selected and used. Beam reporting can be performed repeatedly over time to help with beam management, whereby measurements on reference signals are performed and reported (e.g., as quality indicators) to the base station. To reduce or even avoid unnecessary beam reporting, a prediction of a dwelling time of the UE in the beam is generated. The dwelling time can be referred to herein as a beam dwelling time and represents a time duration during which this already selected beam has a beam quality better than a predefined beam quality or has the highest beam quality for the UE among the beams of the base station (e.g., relative to the UE, the beam has the best quality among the beams). The beam quality can be quantified using one or more measurements on reference signals received on the beam. The predefined beam quality can be quantified by using one or more measurement thresholds. Depending on the measurement types, the beam quality being better than the predefined beam quality corresponds to at least one of the measurements being larger or smaller than a corresponding measurement threshold. Also depending on the measurement types, the beam quality being the best quality corresponds to the at least one of the measurements being the largest or smallest among corresponding measurements performed for the other beams. For instance, a measurement can be a reference signal received power (RSRP). In this case, the predefined beam quality can include an RSRP threshold. The beam quality being better than the predefined beam quality corresponds to the RSPR being larger than the RSRP threshold. The beam quality being the best quality corresponds to the RSRP being the largest RSRP among the RSRPs measured for the beams. In another illustration, a measurement can be a signal plus interference to noise ratio (SINR). In this case, the predefined beam quality can include an SINR threshold. The beam quality being better than the predefined beam quality corresponds to the SINR being larger than the SINR threshold. The beam quality being the best quality corresponds to the SINR, being the largest SINR among the SINRs measured for the beams. As such, during the beam dwelling time, it is expected that the beam remains the best beam to use, and it is unnecessary to perform beam reporting. Thereafter, beam reporting can be advantageously performed.

In an example, the prediction of the dwelling time is generated by an artificial intelligence model trained to generate beam dwelling time predictions. The artificial intelligence model can be trained locally at the base station, the network (e.g., a network node other than the base station), and/or the UE. Regardless of where the training occurs, at the inference stage, the trained artificial intelligence model can be used locally at the base station, the network, or the UE.

In an example of using the artificial intelligence model, the base station can configure the UE to send a first beam report. This beam report may relate to a current transmission configuration indicator (TCI) state. Upon receiving the first beam report, the reported beam index(es) and/or reported reference signal measurements can be input to the artificial intelligence model such that the base station can determine the prediction of the dwelling time. Given this prediction, the base station can configure and/or trigger the UE to send a next beam report.

In another example of using the artificial intelligence, the base station can configure the UE to send a beam dwelling time report. This report may indicate the prediction of the dwelling time to the base station, where the prediction is determined by the UE. Here, the UE performs beam measurements, inputs the relevant information (beam index(es) and/or reference signal measurements) to the artificial intelligence model, and receives an output thereof indicating the prediction. Next, the UE reports the prediction to the base station. In turn, the base station can configure and/or trigger the UE to send a next beam report.

In yet another example of using the artificial intelligence, the base station can configure the UE to send a beam report upon the UE's own determination of the beam dwelling time. Here also, the UE performs beam measurements, inputs the relevant information (beam index(es) and/or reference signal measurements) to the artificial intelligence model, and receives an output thereof indicating the prediction. Based on the time duration of the predicted beam dwelling time, the UE performs and sends a next beam report to the base station absent a trigger by the base station for such a report.

These and other embodiments are further described in connection with the next figures. Generally, by using a prediction of a beam dwelling time, the UE may avoid unnecessary beam reporting, and the base station may avoid unnecessary control signaling and, as applicable, transmission of reference signals (e.g., channel state information reference signal (CSI-RS) to the UE. As such, processing at the UE and the base station can be reduced and the overall overhead can be reduced.

Embodiments of the present disclosure are described in connection with 5G networks. However, the embodiments are not limited as such and similarly apply to other types of communication networks including other types of cellular networks.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

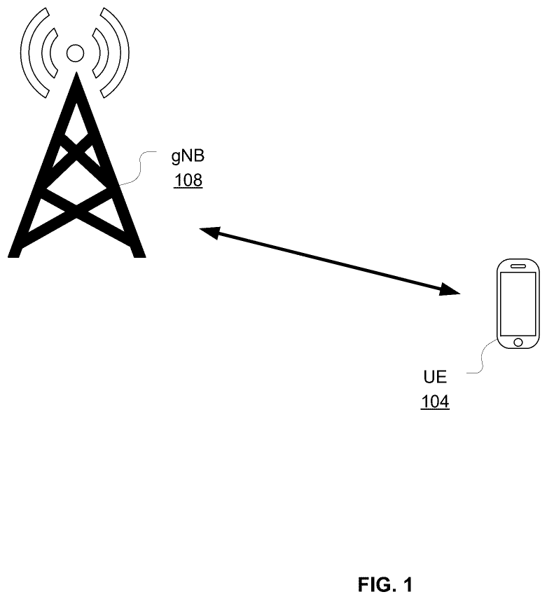

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal block (SSB). The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs (for example, six REGs).

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data), and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

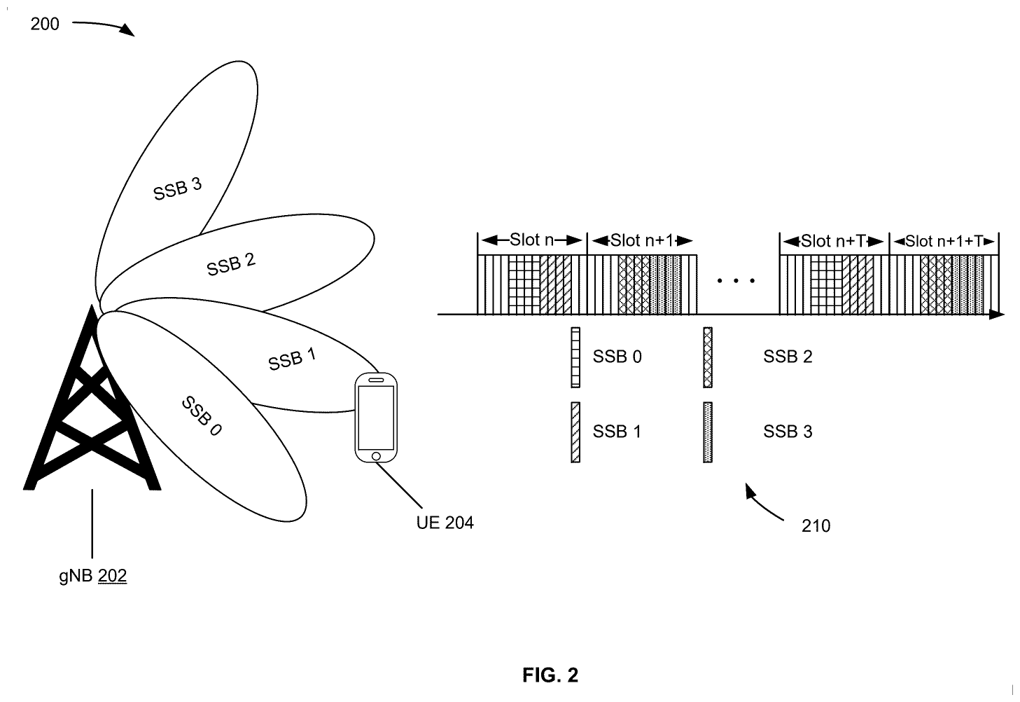

FIG. 2 illustrates an example of beam measurements 200, in accordance with some embodiments. Generally, reference signals are emitted by a gNB 202 on different beams and a UE 204 performs measurements on one or more of the reference signals. For example, instances of a same reference signal are transmitted on the different beams and given the location of the UE 204 relative to the gNB 202, the UE 204 may receive some or all or of these reference signals, perform reference signal received power (RSRP) measurements and/or interference plus noise ratio (SINR) measurements on the received signal(s). The UE 204 may then select the beam having the best measurement(s) (e.g., one having the largest RSRP measurement and/or largest SINR measurement) and indicate this selection to the gNB 202. Or the UE 204 may send the measurements to the gNB 202 to receive back a selection of the beam having the best measurements.

In the interest of clarity of explanation, FIG. 2 illustrate SSBs 210 as an example of the possible reference signals. Other types of reference signals are possible including, for instance CSI-RSs. Accordingly, the embodiments are not limited to SSBs and equivalently apply to CSI-RSs and other types of reference signals. Conversely, when the use of CIS-RSs is described in embodiments of the present disclosure, this use equivalently applies to other types of reference signals including SSBs. Generally, SSB-related measurements can be performed for an initial selection of a first beam. CSI-RS measurements can be performed for beam refinement, whereby a second beam can be selected. The second beam can be a refinement of the first beam by being more directional and having a higher gain. In other words, the second beam can be a narrower beam within the envelope of the wider first beam. Also in the interest of clarity of explanation, equivalent beams may be available from the UE 204 but are not shown in FIG. 2. The beams available from the gNB 202 can be referred to as gNB beams. The beams available from the UE 202 can be referred to as UE beams. gNB-UE beam pair can be formed by a gNB beam and a corresponding UE beam. A gNB-UE beam pair can be generally referred to herein as a beam.

Referring to the illustration of FIG. 2, the beams are shown as SSB beams on the left-hand side of FIG. 2 (but these shown beams could equivalently be CSI-RS beams or each shown can be associated with multiple, narrow CSRI-RS beams). The SSB beams are used by the gNB 202 for transmission of SSBs, shown on the right-hand side of FIG. 2 (but these beams could be equivalently for CSI-RS transmissions).

Generally, the gNB 202 can transmit multiple SSBs in a burst set period, with each SSB potentially in a different beam. These beams are referred to herein as SSB beams (e.g., an analog beam dedicated to a specific SSB). The UE 204 performs beam sweeping to select one or more SSB beams (e.g., an SSB beam that has the best SSB measurement among the SSB beams, where these measurements are performed on the detected SSBs) for communication with the gNB 202. In an RRC connected mode, the UE can perform a beam refinement procedure to select one or more CSI-RS beams (not shown) within the selected

SSB beam. This selection can rely on CSI-RSs transmitted by the gNB 202 and measured by the UE 204.

In the illustration of FIG. 2, the gNB 202 performs beam sweeping to transmit the SSB beams at predefined directions in a burst within a regular interval. These SSB beams are indexed with SSB beam indexes “i” (shown in FIG. 2 as “i” equal to “0,” “1,” “2,” “3”). An SSB caries the PSS, the SSS, and the PBCH and is repeated in the SSB beams in a burst, and this SSB burst is repeated periodically. A cell can be covered by up to four SSB beams for a sub-3 GHz carrier and up to eight SSB beams for a carrier with a 3 to 7 GHz range.

As shown on the right-hand side of FIG. 2, an SSB occupies multiple symbols in a slot (FIG. 2 shows each SSB occupying four symbols in a slot as an illustrative example). Further, the SSBs 210 over different SSB beams can be transmitted back-to-back in clusters. For example, SSB0 and SSB1 are transmitted in a first slot “n,” and SSB2 and SSB3 are transmitted in a second slot “n+1” immediately thereafter. The transmissions can be repeated periodically in other slots, such as SSB0 and SSB1 are transmitted periodically each time in a same slot, and, likewise, SSB2 and SSB3 are transmitted periodically each in a next immediate slot. This is illustrated in FIG. 2 by using periodicity “T,” where the next transmission of SSB0 and SSB1 is in slot “n+T,” and where the next transmission of SSB2 and SSB3 is in slot “n+1+T.”

As shown in FIG. 2, the UE 204 may be in a direct coverage area of SSB beam “1” (this beam is described herein for illustrative purposes only, and the embodiments similarly apply to any other beam and/or type of coverage). For that reason, the SSB measurements associated with SSB beam “1” may the best SSB beam measurements (e.g., have the largest RSRP and/or SINR measurement) and may indicate that the SSB beam “1” has the best quality among the SSB beams. Accordingly, the UE 204 may select SSB beam “1” (assuming that the SSB beam “1” has a sufficient or acceptable SSB measurements, such when at least one of the SSB measurements exceeds a corresponding measurement threshold) and indicate this selection to the gNB 202 (via a physical random-access channel (PRACH) procedure). The UE 204 may also send a beam report to the gNB 202, where the beam report includes the indexes of the measured beams and the corresponding SSB reference signal measurements. Additionally or alternatively, the gNB 202 upon receiving the beam report can indicate to the UE 204 the beam to select and use. This indication can take the form of TCI state information.

A beam may be associated with a TCI state. The TCI state can indicate quasi co-location (QCL) relationships between antenna ports used for reference signals (e.g., SSBs or CSI-RSs) and downlink data or control signaling, for example, PDSCH or PDCCH. The gNB 202 may use a combination of RRC signaling, MAC control element signaling, and DCI to inform the UE 204 of these QCL relationships such that the UE 204 can take advantage of the

QCL relationships to perform measurements (e.g., on reference signals) and generate beam reports.

TCI states are configured for PDCCH, PDSCH and CSI-RS in order to convey the QCL indication for the respective reference signal. In FR1 QCL Types A-C and in FR2 QCL types A-D are applicable. The QCL Type D for FR2 indicates that PDCCH/PDSCH/CSI-RS is transmitted with the same spatial filter as the reference signal associated with that TCI. In FR2, the network can indicate a transmit beam change for PDSCH or PDCCH by switching the TCI state.

The UE 204 may be configured with a TCI list for PDSCH and PDCCH via RRC. The TCI states for PDCCH is a subset of those for PDSCH. For PDCCH, the network configures the active TCI state via MAC CE. RRC can configure up to one-hundred twenty-eight TCI states for PDSCH. The UE can have up to eight activated TCI states via MAC CE, although the embodiments of the present disclosure are not limited as such.

When the UE 204 is configured with the higher layer parameter tci-PresentInDCI that is set as ‘enabled’ for the CORESET scheduling the PDSCH, the TCI field is present in DCI format 1_1. If the scheduling offset between scheduling and PDSCH is larger than Threshold-Sched-Offset and TCI field is present, the TCI state for PDSCH is indicated via DCI. If the tci-PresentInDCI is not configured or PDSCH is scheduled using DCI format 1_0 or the scheduling offset between PDCCH and PDSCH is smaller than Threshold-Sched-Offset, PDSCH follows the TCI of PDCCH. Thresh-old-Sched-Offset is based on UE capability timeDuration-ForQCL.

TCI state change and corresponding beam switch may be initiated via MAC CE or DCI. When TCI for PDSCH is indicated by DCI, the TCI state or beam switch can be configured via DCI. DCI based TCI state switch is applicable to PDSCH. When PDSCH follows the TCI state of PDCCH, for a beam switch the TCI state of PDCCH is first initiated via MAC CE. Hence, MAC CE-based TCI state switch can be applicable to PDCCH.

When the network activates a new TCI state via MAC CE for PDCCH or via DCI for PDSCH, the UE 204 is allowed some time to prepare to receive with the new TCI state. In order to successfully receive with the new TCI state, the UE 204 needs to know the receive (RX) beam corresponding to the new TCI state and the relevant time offset/frequency offset (TO/FO).

As such, usually for beam management, the gNB 202 needs to transmit multiple downlink reference signals for the UE 204 to measure the quality for each beam. Different gNB beams may be applied to different reference signals. The downlink reference signals can be SSBs or CSI-RSs. The UE 204 can use different RX beams to receive different instances of one reference signal to identify the best UE beam for each gNB beam. To identify the gNB-UE beam pair, the UE 204 needs to perform measurement for several gNB beams by following a UE beam sweeping operation. The UE 204 can report the quality of beams to facilitate the beam selection. After receiving the beam report, the gNB 202 can provide a TCI state indication to provide the beam indication. The TCI can be indicated by MAC CE or DCI format 1_1/1_2.

The gNB 202 can also configure and/or trigger the UE 204 to send beam reports repeatedly. However, if the beam report periodicity is too small, the beam reporting may waste UE power and increase the overhead for SSBs/CSI-RSs and the gNB 202 may need to transmit the SSBs/CSI-RSs too frequently. That is because the selected beam may still be the best beam. Conversely, if the beam report periodicity is too large, the already selected beam may get outdated (e.g., relative to the UE 204, this beam may no longer be the best beam among the beams of the gNB 202. As result, the overall performance may be decreased (e.g., data throughput).

To mitigate such challenges, embodiments of the present disclosure involve using a prediction of a dwelling time of the UE 204 in a beam of the gNB 202. Referring back to the illustration of FIG. 2, SSB beam “1” is selected. The dwelling time represents a time duration during which the SSB beam “1” is predicted to continue having the best quality (e.g., the highest reference signal measurements) among the remaining SSB beams. During that time duration, it would not be necessary for the UE 204 to perform additional reference signal measurements and/or send a beam report to the gNB 202, and/or it would not be necessary for the gNB 202 to transmit reference signals to the UE 204 for measurements and beam reporting. At an expiration of the duration, the UE 204 can be configured to automatically or can be triggered by the gNB 202 to perform the relevant measurements and send a beam report at the proper time, and the gNB 202 can be configured to schedule and transmit the relevant reference signals to the UE 204.

In an example, the prediction can be generated by an artificial intelligence model. The input to this model can be a current beam report or a portion thereof. For instance, referring back to the illustration of FIG. 2, the input can include the RSRP and/or SINR measurements corresponding to SSB “1” and, optionally, to the other beams along with the corresponding index(es). The output of the artificial intelligence model can indicate when a beam change may happen. This indication can take the form of the time duration of the predicted dwelling time. The output can also indicate a future time interval for the prediction (e.g., the dwelling time is 100 milliseconds and is predicted for the next 500 milliseconds).

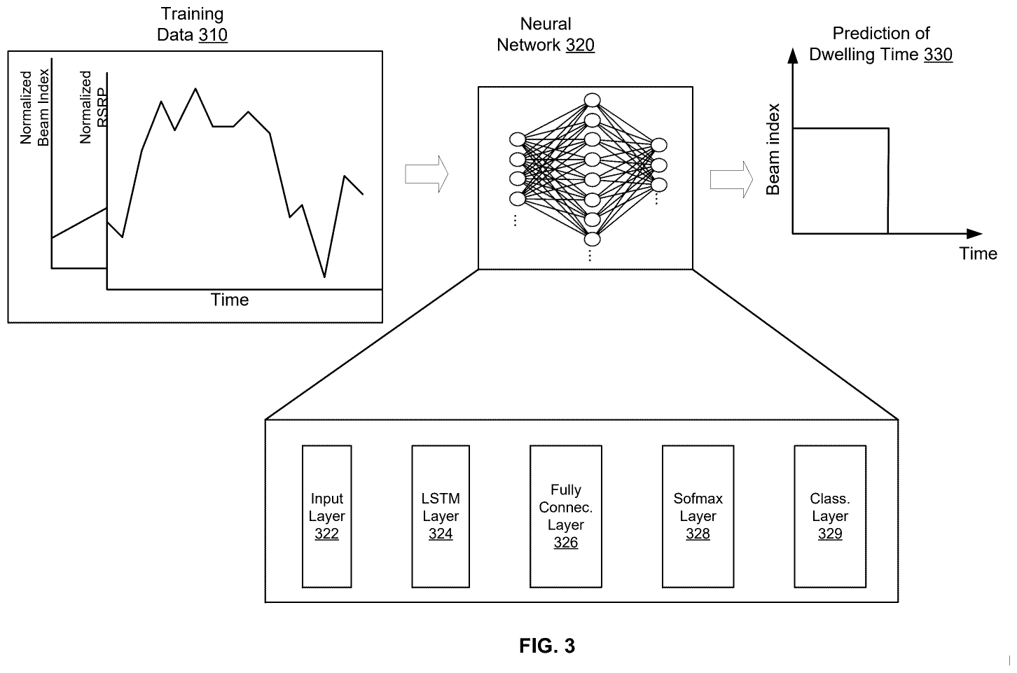

FIG. 3 illustrates an example of using an artificial intelligence model to generate a prediction of a dwelling time, in accordance with some embodiments. The structure of the artificial intelligence model is described first, followed by its training, and then by its use at the inference stage.

As illustrated, the artificial intelligence model is implemented as a neural network 320. The neural network includes at least one of an input layer 322, a long short-term memory (LSTM) layer 324, a fully connected layer 326, a softmax layer 328, and a classification layer 329. Other structures of the neural network 320 are possible. For instance, the softmax layer 328 and the classification layer 329 can be replaced by a regression layer.

Further, other structures of the AI model are possible and can include machine learning models using neural network technologies or other technologies.

The training relies on training data 310. In an example, the training data includes information derived based on past beam reports. For instance, the training data 310 can include beam measurements (e.g., RSRP and/or SINR measurements which may, but need not, be normalized), corresponding beam indexes (which may, but need not, be normalized), corresponding beam selections, and timing (e.g., time stamps) of such measurements and/or of such selections. The timing can indicate how actual dwelling times. An actual dwelling time can correspond to a difference between two time stamps, where one of the time stamps corresponds to when a beam had the best beam measurement or was selected, and wherein the other time stamp corresponds to when the beam measurements of another beam became better or the other beam was selected. indicating when a beam was selected. Alternatively or additionally, an actual dwelling time can correspond to a difference between two time stamps, where one of the time stamps corresponds to when one or more measurements for the beam indicate than the beam had a beam quality better than a predefined beam quality, and wherein the other time stamp corresponds to when one or more subsequent measurements for the beam indicate than the beam had a quality lower than the predefined beam quality.

The training can be performed locally at a base station (e.g., the gNB 202). In this case, the training data 310 relates to multiple UEs. For each UE, a corresponding past beam report can include beam measurements and corresponding beam indexes that the UE reported to the base station. The training data 310 can include such information. Alternatively, the training data 310 can include a portion of such information. In particular, for each UE, the training data 310 can include the beam measurement of the best (or selected) beam and the corresponding beam index.

Alternatively, the training can be performed locally at a UE (e.g., the UE 204). In this case, the training data 310 can relate to past beam reports generated by the UE over a past period of time, where these reports can relate to one or more base stations. Here also, the training data 310 can include all of the beam measurements and the corresponding beam indexes or only the best beam measurements and the corresponding beam indexes.

Alternatively, the training can be performed locally at a network (e.g., a network node of a 5G core network). In this case, the training data 310 can be specific to a base station, in which case the training data 310 is similar to the one described herein above with respect to the base station local training. The training can be specific to a UE, in which case the training data 310 is similar to the one described herein above with respect to the UE local training. The training can be generic to multiple base stations, in which case the training data 310 is similar to the one described herein above with respect to the base station local training except that it applies to the beam measurements and/or beam indexes collected by multiple base stations. The training can be generic to multiple UEs, in which case the training data 310 is similar to the one described herein above with respect to the UE local training except that it applies to the beam measurements and/or beam indexes collected by multiple UEs.

Regardless of where the training is performed, the training can use the actual dwelling times as ground truths, whereby the neural network 320 is trained to generate predicted dwelling times as close as possible to the ground truths. For instance, the training relies on a loss function that uses the actual dwelling times and the predicted dwelling times, and the training is iterative by updating weights of the neural network 320 (e.g., through a backpropagation algorithm) to minimize the loss function.

One training is complete, the neural network 320 can be used (e.g., this use can be referred to as an “inference”). In an example, the neural network 320 is used locally at the base station. In this case, if the training was not local to the base station (e.g., at a training source that can be the UE or the network), the base station can receive weights of the neural network 320 from the training source. In another example, the neural network 320 is used locally at the UE. In this case, if the training was not local to the UE (e.g., at a training source that can be the base station or the network), the UE can receive weights of the neural network 320 from the training source. In yet another example, the neural network 320 is used locally at the network. In this case, if the training was not local to the network (e.g., at a training source that can be the base station or the UE), the network can receive weights of the neural network 320 from the training source.

Regardless of the entity that uses the neural network 320 (e.g., the base station, the UE, and/or the network), the use can involve an input to the neural network 320 that in turn generates an output accessible to the entity. The input can include some or all of the information available in a current beam report. For instance, and referring back to the illustration of FIG. 2, the UE 204 can generate a beam report indicating that SSB beam “1” is the best beam. This beam report (e.g., all the RSRP and/or SINR measurements for all the beams and the corresponding indexes) can be included in the input. Alternatively, only the information about the best beam is included in the input (e.g., the RSRP and/or SINR measurements for SSB beam “2” and the corresponding beam index “2”).

The output can indicate a prediction of a dwelling time 330. For instance, the output includes the predicted time duration of the dwelling time. The output may also include a likelihood of the predicted time duration. The entity may disregard the use of the prediction if the likelihood is smaller than a likelihood threshold (in, which case, the entity may proceed with the configuring, triggering, and/or performing, as applicable, beam reporting independently of the prediction). The output can also indicate that the predicted beam dwelling time is over a future time interval (e.g., for the next “Y” milliseconds”).

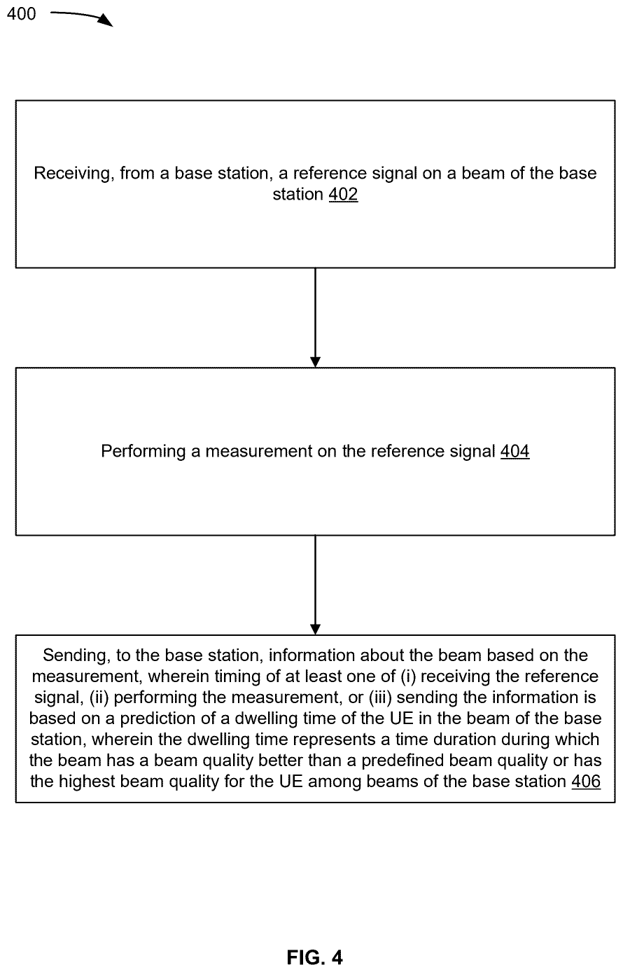

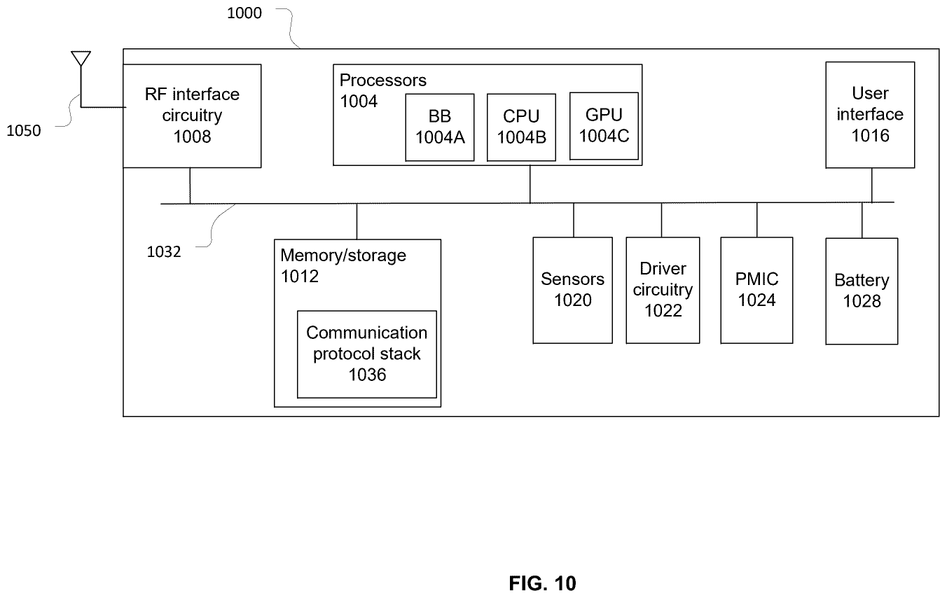

FIG. 4 illustrates an example of an operational flow/algorithmic structure 400 for a UE performing beam reporting, in accordance with some embodiments. The UE is an example of the UE 104, the UE 204, or the UE 1000 further described in FIG. 10.

In an example, the operational flow/algorithmic structure 400 includes, at 402, receiving, from a base station, a reference signal on a beam of the base station. For example, the reference signal can be an instance of an SSB or a CSI-RS. Instances of the reference signal can be received by the UE on multiple beams of the base station.

In an example, the operational flow/algorithmic structure 400 includes, at 404, performing a measurement on the reference signal. For example, the UE receives one or more instances of the SSB or CSI-RS and performs a set of measurements on each received instance. This set can include an RSRP measurement and/or a SINR measurement.

In an example, the operational flow/algorithmic structure 400 includes, at 406, sending, to the base station, information about the beam based on the measurement, wherein timing of at least one of (i) receiving the reference signal, (ii) performing the measurement, or (iii) sending the information is based on a prediction of a dwelling time of the UE in the beam of the base station, wherein the dwelling time represents a time duration during which the beam has a beam quality better than a predefined beam quality or has the highest beam quality for the UE among beams of the base station. As explained herein above, a beam quality can be defined based on reference signal measurements performed for the beam. Being a better beam quality corresponds to at least a reference signal measurement being larger or smaller (depending on the type of this measurement) than a predefined reference signal measurement threshold. Being the best beam quality corresponds to at least a reference signal measurement being the largest or smallest (depending on the type of this measurement) among the same type of reference signal measurements performed for the beams. The information can be sent in a beam report and can include, for instance, the set of measurements and the set of beam indexes corresponding to the beams on which the instances were received and measured. The prediction of the dwelling time can be generated based on an input to an artificial intelligence model. This prediction can be generated locally at the UE. Alternatively, the prediction can be generated locally at the base station, and can receive the prediction to then trigger the beam report (e.g., receiving the reference signal, performing the measurement, and/or sending the information) or can receive instead a trigger from the base station to perform beam reporting, where this trigger is based on the prediction. The input can include past information from a past beam report (e.g., from the latest beam report that indicated that the beam has the highest beam quality and that was used to select the beam). The past information can include the past RSRP/SINR measurements for the beam and/or other beams of the base station and corresponding beam index(es). The output of the artificial intelligence model can include a predicted time duration of the dwelling time.

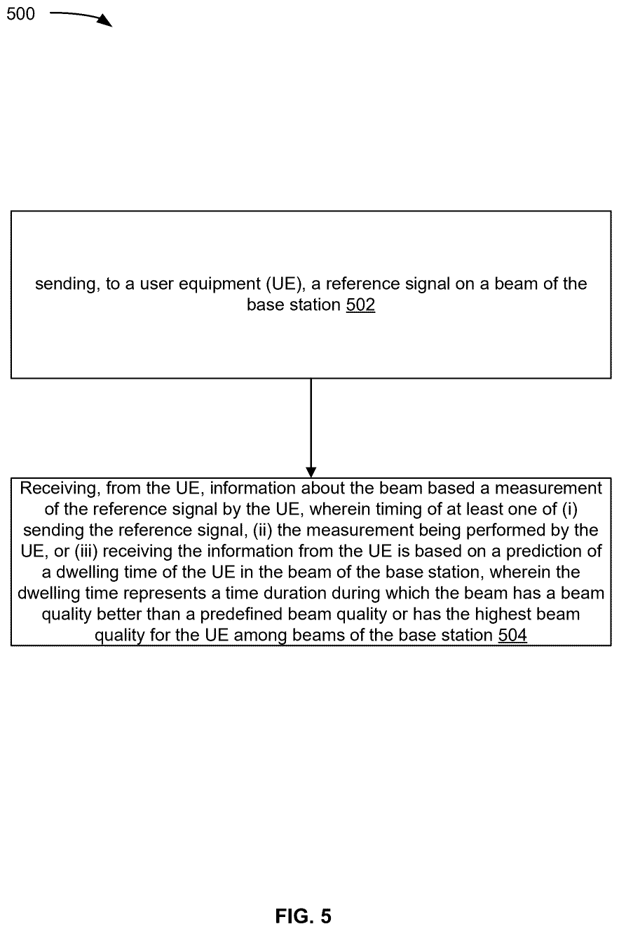

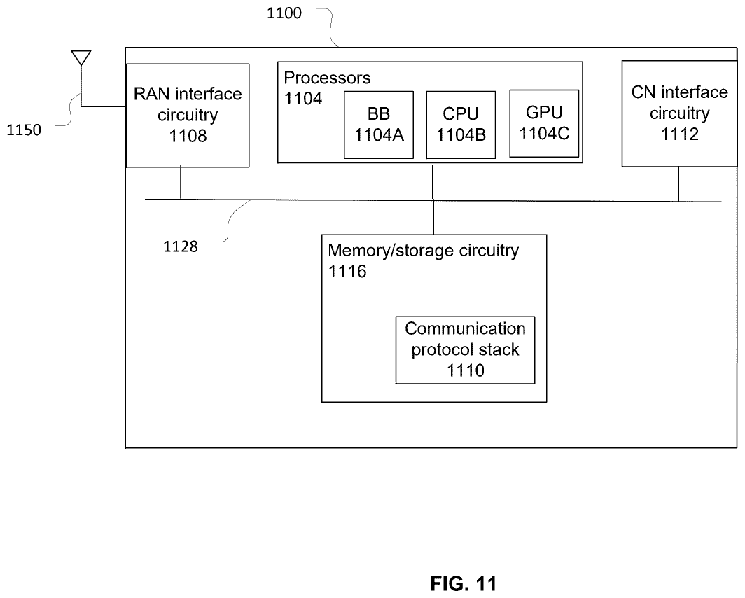

FIG. 5 illustrates an example of an operational flow/algorithmic structure 500 for a base station configuring a UE to perform beam reporting, in accordance with some embodiments. The base station is an example of the gNB 108, the gNB 202, or the gNB 1100 further described in FIG. 11.

In an example, the operational flow/algorithmic structure 500 includes, at 502, sending, to a UE, a reference signal on a beam of the base station. For example, the reference signal can be an instance of an SSB or a CSI-RS. Instances of the reference signal can be sent to the UE on multiple beams of the base station.

In an example, the operational flow/algorithmic structure 500 includes, at 504, receiving, from the UE, information about the beam based a measurement of the reference signal by the UE, wherein timing of at least one of (i) sending the reference signal, (ii) the measurement being performed by the UE, or (iii) receiving the information from the UE is based on a prediction of a dwelling time of the UE in the beam of the base station, wherein the dwelling time represents a time duration during which the beam has a beam quality better than a predefined beam quality or has the highest beam quality for the UE among beams of the base station. The information can be received in a beam report and can include, for instance, a set of measurements and a set of beam indexes corresponding to the beams on which the instances were received and measured by the UE. The prediction of the dwelling time can be generated based on an input to an artificial intelligence model. This prediction can be generated locally at the base station. Alternatively, the prediction can be generated locally at the UE, and the base station can receive the prediction to then trigger beam reporting at the UE (e.g., sending the reference signal, the measurement being performing, and/or the information being received), or can automatically receive the beam report without the need to trigger the UE to do so. The input can include past information from a past beam report (e.g., from the latest beam report that indicated that the beam has the highest beam quality and that was used to select the beam). The past information can include the past RSRP/SINR measurements for the beam and/or other beams of the base station and corresponding beam index(es). The output of the artificial intelligence model can include a predicted time duration of the dwelling time.

The operational flow/algorithmic structure 400 of FIG. 4 can be used in conjunction with the operational flow/algorithmic structure 500 of FIG. 5. Each operation of each of these operational flow/algorithmic structures 400 and 500 can include a set of steps. Such steps are further described in the next figures and can depend on whether an artificial intelligence model is configured for use by the base station or the UE to generate the prediction of the dwelling time.

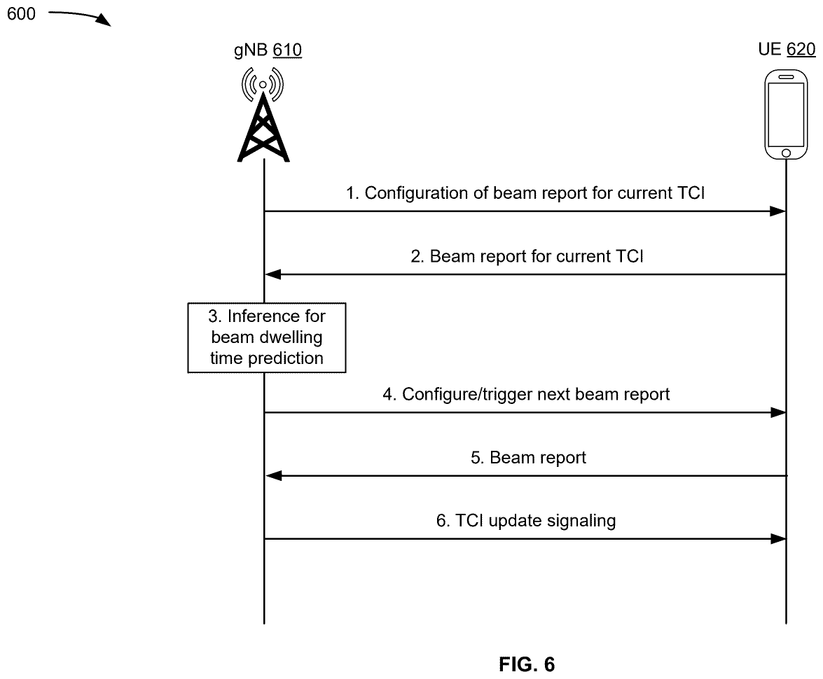

FIG. 6 illustrates an example of a sequence diagram 600 that involves a base station 610 and a UE 620 supporting beam management, in accordance with some embodiments. In this sequence diagram 600, an artificial intelligence model is configured for use by the base station 610 to generate a prediction of a dwelling time. The prediction is used as part of the beam management.

Generally, the base station 610 can configure the UE 620 to send a first beam report. This beam report may relate to a current transmission configuration indicator (TCI) state. Upon receiving the first beam report, the reported beam index(es) and/or reported reference signal measurements can be input to the artificial intelligence model such that the base station 610 can determine the prediction of the dwelling time. Given this prediction, the base station 610 can configure and/or trigger the UE 620 to send a next beam report. Steps to do so are enumerated as “1” through “6” in the sequence diagram 600. Each of these steps is described herein next.

In an example, a first step of the sequence diagram 600 includes the network (e.g., via the base station 610) sending configuration information to the UE 620 associated with beam reporting for a current TCI. For instance, the base station 610 configures a CSI-reportConfig that necessitates the UE 620 to report the beam quality for at least the SSB/CSI-RS QCLed with or the same as the reference signal indicated in a set of current TCI states. In one example, an RRC parameter introduced for a CSI-reportConfig can be used for the configuration. In another example, a dedicated identifier of a CSI-reportConfig (e.g., CSI-reportConfigId) may be configured or predefined to be used for beam reporting for the set of the current TCI States. In another example, a field for a medica access control (MAC) control element (CE) CE for a semi-persistent CSI report can be used. This new field may take one bit to indicate whether the CSI report necessitates the UE 620 to report the beam quality for set of current TCI states or perform a normal beam report. In another example, a field or a candidate value of an existing field (e.g., CSI request) in DCI can be used to indicate whether the triggered beam report is for set of the current TCI states or a normal beam report.

A second step of the sequence diagram 600 includes the UE 620 sending a beam report to the base station 610 based on the configuration information. For instance, the UE 620 can report the beam quality (e.g., Layer (L1)-RSRP/L1-SINR for a set of current indicated TCI states). In one example, if only one TCI state is indicated, UE may only report the L1-RSRP/L1-SINR that is associated with hat state. In another example, if “N” (“N>1” and is a positive integer) TCI states are indicated, the UE 620 may report “N” L1-RSRP/L1-SINR. In another example, if “N” (“N>1” and is a positive integer) TCI states are indicated, and the number of reported TCI states is configured as “M” “(M<N” and is a positive integer), the UE 620 may report “M” L1-RSRP/L1-SINR as well as “M” TCI State index.

A third step of the sequence diagram 600 includes the base station 610 performing an inference for beam dwelling time prediction. For instance, the base station 610 receives the beam report, determines the beam measurement(s) and beam index(es) included therein, perform any needed beam measurement normalization and/or beam index normalization to generate an input to the artificial intelligence model. In turn, the artificial intelligence model outputs the prediction of the dwelling time.

A fourth step of the sequence diagram 600 includes the base station 610 configuring or triggering the UE 620 to send a next beam report. The configuring can involve sending additional configuration information to the UE 620 and/or activating one of the previously configured beam reports (e.g., per the first step). Triggering can involve sending an indication that the beam reporting is to be performed and the timing of doing so.

In particular, after predicting the beam dwelling time, the base station 610 can decide when to trigger the beam report and inform UE 620 when the UE 620 is to start the beam measurement and send potential beam report. In one example, the base station 610 can activate/deactivate CSI-reportConfig for beam report (e.g., L1-RSRP/L1-SINR report) by MAC CE or DCI. In another example, the base station 610 can trigger a CSI-report with a large delay, where the delay may be provided by MAC CE or DCI. The delay can be indicated in an offset format (e.g., the time duration between beam report triggering and beam reporting time). The dela can also or alternatively be indicated in absolute time (e.g., a system frame number (SFN) and slot index of the beam reporting time is indicated). Alternatively, the base station 610 can decide the time to trigger CSI-RS for beam reporting and/or update the periodicity for periodic/semi-persistent CSI-RS for beam reporting by

MAC CE or DCI.

A fifth step of the sequence diagram 600 includes the UE 620 sending a beam report to the base station 610 based on the information received at the fourth step. For instance, after receiving the control signaling from the fourth step, the UE 620 performs beam measurement and report at the indicated time. Before that, the UE 620 does not need to perform beam measurement for the corresponding beams configured in CSI-reportConfig, thereby the UE's 620 power consumption can be reduced and UE power can be saved.

A sixth step of the sequence diagram 600 includes the base station 610 sending TCI update signaling to the UE 620. This signaling can indicate that another beam of the base station 610 is to be selected and user by the UE 620. In particular, the TCI update signaling may be provided to update the beam based on latest beam report. This step may be optional depending on, for instance, the need for a beam reselection.

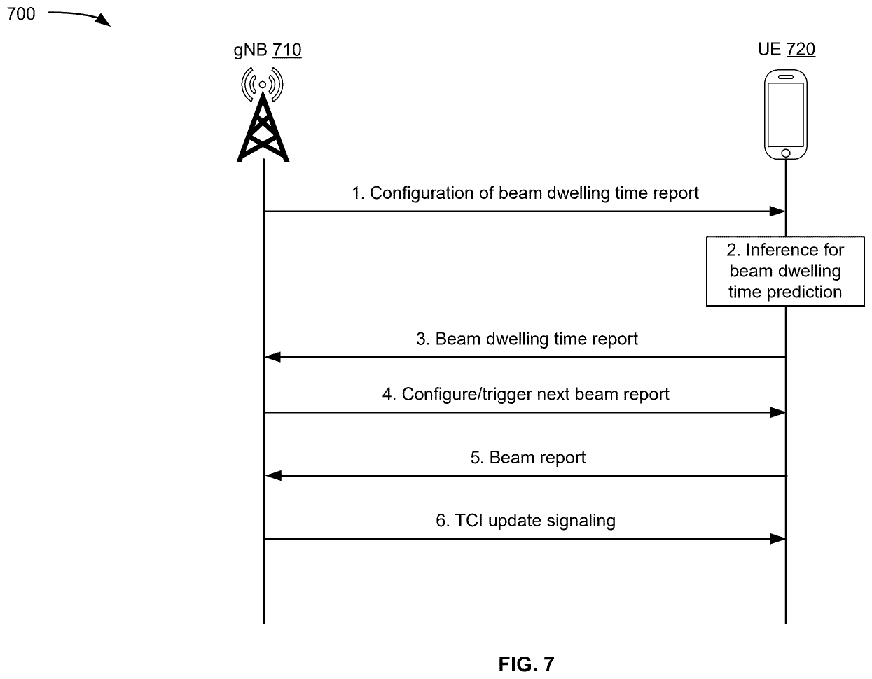

FIG. 7 illustrates another example of a sequence diagram 700 that involves a base station 710 and a UE 720 supporting beam management, in accordance with some embodiments. In this sequence diagram 700, an artificial intelligence model is configured for use by the UE 720 to generate a prediction of a dwelling time. The prediction is used as part of the beam management.

Generally, the base station 710 can configure the UE 720 to send a beam dwelling time report. This report may indicate the prediction of the dwelling time to the base station 710, where the prediction is determined by the UE 720. Here, the UE 720 performs beam measurements, inputs the relevant information (beam index(es) and/or reference signal measurements) to the artificial intelligence model, and receives an output thereof indicating the prediction. Next, the UE 720 reports the prediction to the base station. In turn, the base station 710 can configure and/or trigger the UE 720 to send a next beam report. Steps to do so are enumerated as “1” through “6” in the sequence diagram 700. Each of these steps is described herein next.

In an example, a first step of the sequence diagram 700 includes the network (e.g., via the base station 710) sending configuration information to the UE 720 associated with beam dwelling time reporting. For instance, the configuration information can indicate to the UE 720 that the UE 720 is to report the prediction of the dwelling time to the base station. In addition, the configuration information can configure the UE to perform the relevant beam measurements that would be used to generate the input to the artificial intelligence model. In an example, the beam dwelling time report may be triggered by higher layer signaling (e.g., RRC or MAC CE, or DCI). The UE 720 can report the minimal time for beam dwelling time prediction as a UE capability. This UE capability can be sent in response to a UE capability enquiry as a UE capability response prior to the first step of the sequence diagram 700. The UE capability response can include a value indicating this minimal time, where this minimal time is needed by the UE to perform the relevant beam measurements, generate the input to the artificial intelligence model, receive the output of the artificial intelligence model indicating the prediction, and preparing the beam dwelling time report. This beam dwelling time can be quantized by number of SSB/CSI-RS instances for a set of the current TCI states. After the initial configuration of the beam dwelling time report, the triggering of the report may not be earlier than the UE capability (e.g., the UE 720 may be triggered or expected to send the prediction of the dwelling time to the base station 710 until after the minimal time needed by the UE 720 to generate this prediction).

A second step of the sequence diagram 700 includes the UE 720 performing an inference for beam dwelling time prediction. For instance, the UE 720 performs beams measurements on a set of SSBs and/or CSI-RSs based on a configuration for beam measurements (this configuration can be similar to the one of the first step of the sequence diagram 600) or retrieve the latest beam measurement report (which was generated based on such a configuration). The UE 720 can input such beam measurement(s) and the corresponding beam index(es), after performing any needed beam measurement normalization and/or beam index normalization, to the artificial intelligence model. In turn, the artificial intelligence model outputs the prediction of the dwelling time.

A third step of the sequence diagram 700 includes the UE 720 sending a beam dwelling time report to the base station 710. In other words, the UE 720 indicates the prediction to the base station 710 by sending predicted information in the beam dwelling time report to the base station 710. The prediction (or at least the predicted time duration of the dwelling time) may be reported as UCI carried by PUCCH/PUSCH or reported by MAC CE. The predicted time duration may be quantized by the number of SSB/CSI-RS periodicities. Further, a maximum number that can be reported can be configured by higher layer signaling (e.g.,) RRC signaling or MAC CE). A UE capability can be introduced to report how far UE can predict for the dwelling time (e.g., the predicted time duration is over a future time interval of “Y” milliseconds). An acknowledgment/negative acknowledgment (ACK/NACK) mechanism for responding to the sending of the beam dwelling time report may be used. For instance, the base station 710 can respond with an ACK/NACK. The ACK/NACK may be DCI corresponding to a dedicated radio network temporary identifier (RNTI) or transmitted in a dedicated search space or scheduling a new transmission for a hybrid automatic repeat request (HARQ) process used for beam dwelling time reporting. After reporting the beam dwelling time or receiving the ACK for the beam dwelling time, the UE 720 may not perform beam measurement until receiving signaling from the next, fourth step.

A fourth step of the sequence diagram 700 includes the base station 710 configuring or triggering the UE 720 to send a next beam report. This step is similar to the fourth step of the sequence diagram 600 of FIG. 6.

A fifth step of the sequence diagram 700 includes the UE 720 sending a beam report to the base station 710 based on the information received at the fourth step. This step is similar to the fifth step of the sequence diagram 600 of FIG. 6.

A sixth step of the sequence diagram 700 includes the base station 710 sending TCI update signaling to the UE 720. This step is similar to the sixth step of the sequence diagram 600 of FIG. 6.

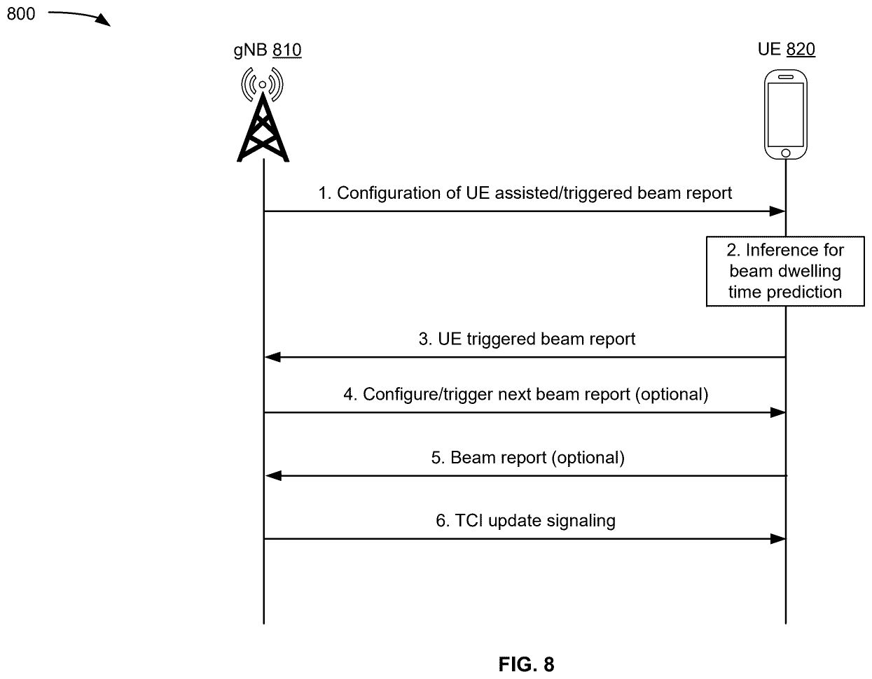

FIG. 8 illustrates yet another example of a sequence diagram 800 that involves a base station 810 and a UE 820 supporting beam management, in accordance with some embodiments. In this sequence diagram 800, an artificial intelligence model is configured for use by the UE 820 to generate a prediction of a dwelling time. The prediction is used as part of the beam management.

Generally, the base station 810 can configure the UE 820 to send a beam report upon the UE's 820 own determination of the beam dwelling time. The UE 820 performs beam measurements, inputs the relevant information (beam index(es) and/or reference signal measurements) to the artificial intelligence model, and receives an output thereof indicating the prediction. Based on the time duration of the predicted beam dwelling time, the UE 820 performs and sends a next beam report to the base station 810 absent a trigger by the base station 810 for such a report. Steps to do so are enumerated as “1” through “6” in the sequence diagram 800. Each of these steps is described herein next.

In an example, a first step of the sequence diagram 800 includes the network (e.g., via the base station 810) sending configuration information to the UE 820 associated with UE-assisted/triggered beam reporting. For instance, the configuration information can indicate to the UE 820 that the UE 820 is to generate the prediction of the dwelling time, but need not report this dwelling time to the base station 810. Further, the configuration information can indicate to the UE 820 that the UE is to perform beam measurements and/or prepare and send a beam report based on the prediction absent a trigger from the base station 810 for the UE 820 to do so. In an example, the configuration information can be sent by RRC signaling.

A second step of the sequence diagram 800 includes the UE 820, performing an inference for beam dwelling time prediction. This step is similar to the second step of the sequence diagram 700 of FIG. 7.

A third step of the sequence diagram 800 includes the UE 820 sending a UE-triggered beam report to the base station 810. In other words, based on the prediction of the dwelling time, the UE performs beam measurements, prepares, and sends a beam report according to the configuration information received in the first step of the sequence diagram 800. In an example, the UE 820 itself (rather than the base station 810) may trigger a beam report after the beam dwelling time prediction when the UE 820 determines that the predicted beam dwelling timer has expired (or is about to expire, before the expiration by a time interval, where this time interval corresponds to the processing latency associated with the UE 820 performing beam measurements and generating the beam report). In an example, a dedicated scheduling request (SR) may be configured for UE to trigger the beam report, where the scheduling request can request the base station 810 to schedule uplink resources for the UE 820 to transmit the beam report. In another example, a dedicated PUCCH/PUSCH resource may be configured for UE to directly report the beam quality for “N” SSBs/CSI-RSs. In yet another example, a list of SSBs/CSI-RSs may be configured by higher layer signaling for the UE to perform beam measurements (e.g., as part of the configuration information discussed in the first step of the sequence diagram 600). The UE may report the beam quality as UCI carried by PUCCH/PUSCH or as a MAC CE. To determine the timing of performing the beam measurements and/or sending the beam report, the UE can maintain a beam dwelling timer (e.g., a count-down timer). The beam dwelling timer can start after UE 820 receives the initial configuration in first step of the sequence diagram 800. The duration of this beam dwelling timer duration can be determined based the predicted beam dwelling time (e.g., equal to the predicted beam dwelling time minus the processing latency associated with the UE 820 performing beam measurements and/or generating the beam report). Upon an expiration of the beam dwelling timer, the UE 820 can perform the beam measurements and/or send the beam report. Further, the beam dwelling timer may be reset after UE 820 reports the beam quality, after UE 820 receives a control signaling to trigger a beam report, or after UE 820 receives an ACK from the base station 820 in response to the sending of the beam report. Here also, like the ACK/NACK mechanism of the third step of the sequence diagram 700 can be applied.

A fourth step of the sequence diagram 800 includes the base station 810 configuring or triggering the UE 820 to send a next beam report. This step is similar to the fourth step of the sequence diagram 600 of FIG. 6. Further, this step may be optional because a beam report has already been sent by the UE 820 to the base station based on the prediction of the dwelling time. Nonetheless, the base station 810 can further request the UE 820 to perform and sent another beam report.

A fifth step of the sequence diagram 800 includes the UE 820 sending a beam report to the base station 810 based on the information received at the fourth step. This step is similar to the fifth step of the sequence diagram 600 of FIG. 6. Further, this step may be optional and is performed only if the base station 810 has request ed the UE 820 to perform and send another beam report at the fourth step of the sequence diagram 800.

A sixth step of the sequence diagram 800 includes the base station 810 sending TCI update signaling to the UE 820. This step is similar to the sixth step of the sequence diagram 600 of FIG. 6.

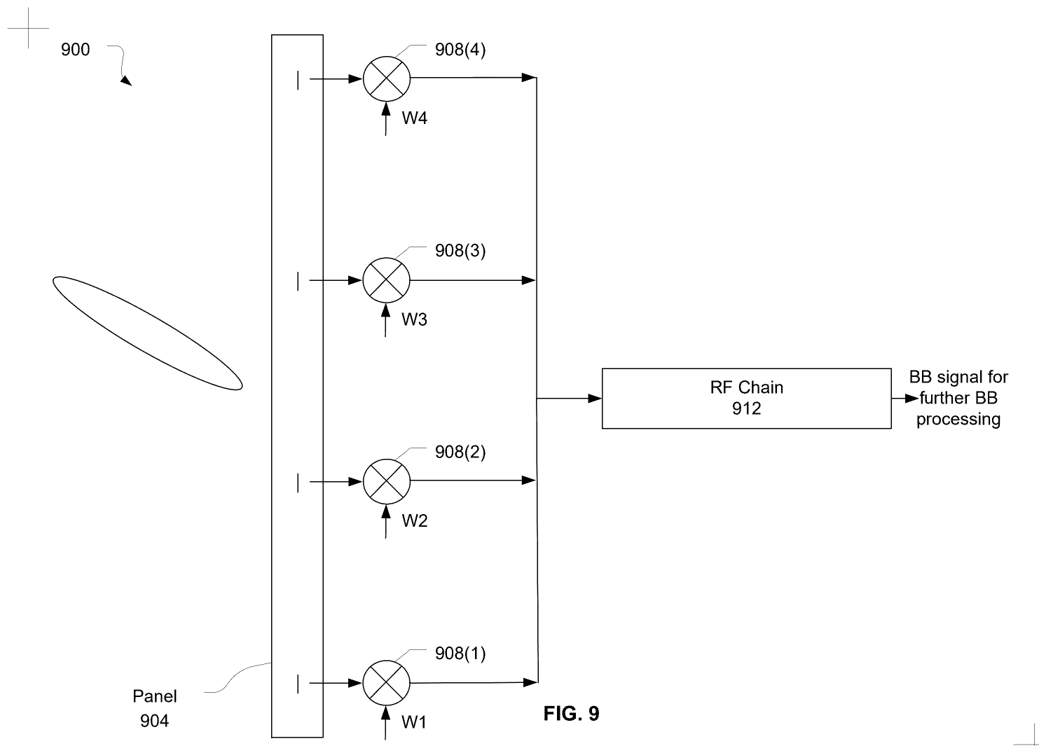

FIG. 9 illustrates receive components 900 of the UE 104, in accordance with some embodiments. The receive components 900 may include an antenna panel 904 that includes a number of antenna elements. The panel 904 is shown with four antenna elements, but other embodiments may include other numbers.

The antenna panel 904 may be coupled to analog beamforming (BF) components that include a number of phase shifters 908 (1)-908 (4). The phase shifters 908 (1)-908 (4) may be coupled with a radio-frequency (RF) chain 912. The RF chain 912 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 908(1)-908(4) to provide a receive beam at the antenna panel 904. These BF weights may be determined based on the channel-based beamforming.

FIG. 10 illustrates a UE 1000, in accordance with some embodiments. The UE 1000 may be similar to and substantially interchangeable with UE 104 of FIG. 1.

Similar to that described above with respect to UE 104, the UE 1000 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1000 may include processors 1004, RF interface circuitry 1008, memory/storage 1012, user interface 1016, sensors 1020, driver circuitry 1022, power management integrated circuit (PMIC) 1024, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry, such as baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1004A may also access group information from memory/storage 1012 to determine search space groups in which a number of repetitions of a PDCCH may be transmitted.

The memory/storage 1012 may include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1050 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1050.

In various embodiments, the RF interface circuitry 1008 may be configured to transmit/receive signals in a manner compatible with NR access technologies.

The antenna 1050 may include a number of antenna elements that each convert electrical signals into radio waves to travel through the air and to convert received radio waves into electrical signals. The antenna elements may be arranged into one or more antenna panels. The antenna 1050 may have antenna panels that are omnidirectional, directional, or a combination thereof to enable beamforming and multiple input, multiple output communications. The antenna 1050 may include microstrip antennas, printed antennas fabricated on the surface of one or more printed circuit boards, patch antennas, phased array antennas, etc. The antenna 1050 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC_Idle state, where it disconnects from the network and does not perform operations, such as channel quality feedback, handover, etc. The UE 1000 goes into a very low power state and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

FIG. 11 illustrates a gNB 1100, in accordance with some embodiments. The gNB 1100 may be similar to and substantially interchangeable with the gNB 108 of FIG. 1.

The gNB 1100 may include processors 1104, RAN interface circuitry 1108, core network (CN) interface circuitry 1112, and memory/storage circuitry 1116.

The components of the gNB 1100 may be coupled with various other components over one or more interconnects 1128.

The processors 1104, RAN interface circuitry 1108, memory/storage circuitry 1116 (including communication protocol stack 1110), antenna 1150, and interconnects 1128 may be similar to like-named elements shown and described with respect to FIG. 10.

The CN interface circuitry 1112 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes a method implemented by a user equipment (UE), the method comprising: receiving, from a base station, a reference signal on a beam of the base station; performing a measurement on the reference signal; and sending, to the base station, information about the beam based on the measurement, wherein timing of at least one of (i) receiving the reference signal, (ii) performing the measurement, or (iii) sending the information is based on a prediction of a dwelling time of the UE in the beam of the base station, wherein the dwelling time represents a time duration during which the beam has a beam quality better than a predefined beam quality or the highest beam quality for the UE among beams of the base station.

Example 2 includes a method of example 1, further comprising: generating the prediction of the dwelling time based on an input to an artificial intelligence model implemented by the UE.

Example 3 includes a method of example 2, wherein the input includes a past measurement performed on a previously received reference signal on the beam.

Example 4 includes a method of example 2, further comprising: training the artificial intelligence model based on training data, wherein the training data includes past reference signal measurements and respective beams indices.

Example 5 includes a method of example 2, further comprising: receiving, from the base station, weights of the artificial intelligence model, wherein the weights are determined based on a training of the artificial intelligence model at the base station.

Example 6 includes a method of example 1, further comprising: sending, to the base station, a past measurement performed on a previously received reference signal on the beam; and receiving, from the base station, the prediction of the dwelling time, wherein the prediction of the dwelling time is included in an output of an artificial intelligence model of the base station, and wherein the output is based on the past measurement and indicates that the dwelling time is predicted over a future time interval.

Example 7 includes a method of example 1, further comprising: training an artificial intelligence model based on training data, wherein the training data includes past reference signal measurements and respective beams indices; sending, to the base station, weights of the artificial intelligence model, wherein the base station stores an instance of the artificial intelligence model; and receiving, from the base station, the prediction of the dwelling time based on an output of the instance.

Example 8 includes a method of any preceding example, wherein the prediction of the dwelling time includes a predicted dwelling time that is quantized as a number of reference signal instances with an interval for a set of current transmission configuration indicator (TCI) states.

Example 9 includes a method of any preceding example, further comprising: receiving, from the base station, configuration information indicating that the UE is to perform beam reporting; and receiving, from the base station and after receiving the configuration information, a beam report trigger that is based on the prediction of the dwelling time, wherein the prediction of the dwelling time is generated by the base station.

Example 10 includes a method of example 9, further comprising: determining a transmission configuration indicator (TCI) state indicated by the configuration information; generating a first beam report based on the TCI state; and sending the first beam report to the base station, wherein the prediction of the dwelling time is generated based on the first beam report.

Example 11 includes a method of example 10, further comprising: determining, based on the beam report trigger, timing for a second beam report, wherein the beam report trigger is received after the first beam report is sent; generating the second beam report based on the timing for the second beam report, wherein the second beam report includes the information about the beam; and sending the second beam report to the base station.

Example 12 includes a method of example 10, wherein the configuration information indicates a single TCI state, and wherein the first beam report includes at least one of: a single layer 1 reference signal received power (L1-RSRP) or a single layer 1 signal to interference plus noise ratio (L1-SINR).

Example 13 includes a method of example 10, wherein the configuration information indicates “N” TCI states, wherein the first beam report includes at least one of: “N” layer 1 reference signal received powers (L1-RSRPs) or “N” layer 1 signal to interference plus noise ratios (L1-SINRs), wherein “N” is a positive integer.

Example 14 includes a method of example 10, wherein the configuration information indicates “N” TCI states, wherein the first beam report includes at least one of: “M” layer 1 reference signal received powers (L1-RSRPs) or “M” layer 1 signal to interference plus noise ratios (L1-SINRs), wherein “N” and “M” are positive integers and “M<N”.

Example 15 includes a method of example 1, further comprising: generating the prediction of the dwelling time; and sending the prediction of the dwelling time to the base station, wherein the UE is triggered by the base station to perform beam reporting based on the prediction of the dwelling time.

Example 16 includes a method of example 15, wherein the prediction of the dwelling time includes a predicted beam dwelling time that is quantized by a number of reference signals for a set of current transmission configuration indicator (TCI) states.

Example 17 includes a method of example 15, further comprising: sending, to the base station, UE capability information indicating a minimal time to generate a beam dwelling time prediction; and receiving, based on the UE capability information, configuration information associated with generating the beam dwelling time prediction, wherein the configuration information indicates that the prediction of the dwelling time is to be generated no earlier than the minimal time.

Example 18 includes a method of example 17, further comprising: sending, to the base station, a beam dwelling time report that indicates the prediction of the dwelling time; receiving, from the base station based on the beam dwelling time report, an indication to generate a beam report; generating the beam report based on the indication, wherein the beam report includes the information about the beam; and sending the beam report to the base station.

Example 19 includes a method of example 15, wherein the prediction of the dwelling time is sent as uplink control information (UCI) carried by a physical uplink control channel (PUCCH) or a physical uplink shared channel (PUSCH).

Example 20 includes a method of example 19, wherein the prediction of the dwelling time includes a predicted dwelling time quantized by a number of reference signal periodicities.

Example 21 includes a method of example 15, further comprising: sending, to the base station, an indication that a beam dwelling time can be predicted over a time interval.

Example 22 includes a method of example 15, further comprising: sending the prediction of the dwelling time in a beam dwelling time report; determining whether download control information (DCI) of the base station indicates that an acknowledgement (ACK) or a negative acknowledgement (NACK) is received in response to sending of the prediction of the dwelling time; receiving, after sending the beam dwelling report or receiving the ACK, indication of the base station for the UE to generate a beam report; and generating, based on the indication, the beam report that includes the information about the beam.

Example 23 includes a method of example 1, further comprising: generating the prediction of the dwelling time; generating, based on the prediction of the dwelling time, a beam report that includes the information about the beam; and sending the beam report to the base station absent a trigger from the base station to send the beam report.

Example 24 includes a method of example 23, further comprising: receiving, from the base station, configuration information associated with generating a beam dwelling time prediction and an indication that a beam report is to be generated, wherein the prediction of the dwelling time is performed based on the configuration information; and generating the beam report based on the prediction of the dwelling time and the indication, wherein the beam report includes the information about the beam.

Example 25 includes a method of example 23, wherein the beam report indicates beam quality for “N” reference signals, wherein “N” is a positive integer.

Example 26 includes a method of example 23, further comprising: receiving, from the base station, configuration information indicating a list of reference signals, wherein the beam report indicates beam quality for the reference signals and is sent as uplink control information.

Example 27 includes a method of example 23, further comprising: receiving, from the base station, configuration information associated with generating a beam dwelling time prediction; starting a beam dwelling timer after the configuration information is received, wherein a duration of the beam dwelling timer is based on the prediction of the dwelling time; generating a beam report based on an expiration of the beam dwelling timer, wherein the beam report includes the information about the beam; and sending the beam report to the base station.

Example 28 includes a method of example 27, further comprising: resetting the beam dwelling timer based on at least one of: sending the beam report, receiving control information from the base station to generate another beam report, or receiving an acknowledgement (ACK) in response to sending the beam report.

Example 29 includes a method implemented by a base station, the method comprising: sending, to a user equipment (UE), a reference signal on a beam of the base station; and receiving, from the UE, information about the beam based a measurement of the reference signal by the UE, wherein timing of at least one of (i) sending the reference signal, (ii) the measurement being performed by the UE, or (iii) receiving the information from the UE is based on a prediction of a dwelling time of the UE in the beam of the base station, wherein the dwelling time represents a time duration during which the beam has a beam quality better than a predefined beam quality or the highest beam quality for the UE among beams of the base

Example 30 includes a method of example 29, further comprising: generating the prediction of the dwelling time based on an input to an artificial intelligence model implemented by the base station.

Example 31 includes a method of example 30, further comprising: receiving, from the UE, a past measurement performed on a previously received reference signal on the beam, and wherein the input includes the past measurement.

Example 32 includes a method of example 31, further comprising: training the artificial intelligence model based on training data, wherein the training data includes past reference signal measurements and respective beams indices.

Example 33 includes a method of example 29, further comprising: sending, to the UE, weights for an instance of an artificial intelligence trained to predict dwelling times, wherein the instance is stored by the UE, and wherein the prediction of the dwell time is generated by the UE based on an input to the instance.

Example 34 includes a method of example 29, further comprising: receiving, from the UE, weights for an instance of an artificial intelligence trained to predict dwelling times, wherein the instance is stored by the base station; determining, based on an output of the instance, the prediction of the dwelling time; and sending, to the UE, the prediction of the dwelling time.

Example 35 includes a method of example 29 further comprising: sending, to the UE, configuration information indicating that the UE is to perform beam reporting; and sending, to the UE and after sending the configuration information, a beam report trigger that is based on the prediction of the dwelling time, wherein the prediction of the dwelling time is generated by the base station.

Example 36 includes a method of example 35 further comprising: receiving, from the UE after the configuration information is sent and before the beam report trigger is sent, a first beam report; generating the prediction of the dwelling time based on the first beam report; and receiving, from the UE a second beam report in response to the beam report trigger, wherein the second beam report includes the information about the beam.

Example 37 includes a method of example 35, wherein the configuration information indicates that the UE is to report beam quality for at least a second reference signal that is quasi co-located with a first reference signal indicated in a set of current transmission configuration indicator (TCI) states or that is the same as the first reference signal.

Example 38 includes a method of example 37, wherein the configuration information is sent in a radio resource control (RRC) parameter for a first CSI-reportConfig or as dedicated identifier of a second CSI-reportConfig associated with beam reporting for the set of current TCI states.

Example 39 includes a method of example 37, wherein the configuration information is sent in a media access control (MAC) control element (CE) for semi-persistent channel state information (CSI) reporting.

Example 40 includes a method of example 39, wherein the MAC CE element includes a bit that indicates whether the CSI reporting requires the UE to report a beam quality for the set of current TCI states or not.

Example 41 includes a method of example 37, wherein the configuration information is sent in downlink control information (DCI), wherein the DCI indicates whether CSI reporting requires the UE to report a beam quality for the set of current TCI states or not.

Example 42 includes a method of example 35, wherein the beam report trigger corresponds to an activation of a CSI-reportConfig for beam reporting by a media access control (MAC) control element (CE) or downlink control information (DCI).

Example 43 includes a method of example 35, wherein the beam report trigger corresponds to a trigger a CSI-report having a delay indicated by a media access control (MAC) control element (CE) or downlink control information (DCI).

Example 44 includes a method of example 35, wherein the beam report trigger corresponds to a trigger a for a channel state information reference signal (CSI-RS) for beam reporting or to a periodicity of a semi-persistent CSI-RS for beam reporting.

Example 45 includes a method of example 29, further comprising: receiving the prediction of the dwelling time from the UE; and sending, to the UE based on the prediction of the dwelling time, a trigger to perform beam reporting.

Example 46 includes a method of example 45, further comprising: sending, before receiving the prediction of the dwelling time, configuration information associated with generating a beam dwelling time report; and receiving, from the UE based on the configuration information, the beam dwelling time report that includes the prediction of the dwelling time.

Example 47 includes a method of example 29, further comprising: receiving, from the UE, a beam report that includes the information about the beam, wherein the beam report is sent by the UE based on the prediction of the dwelling time and absent a trigger by the base station to the UE to send the beam report.

Example 48 includes a method of example 47, further comprising: sending, before receiving the beam report, configuration information associated with generating the beam report based on the prediction of the dwelling time.

Example 49 includes a UE comprising means to perform one or more elements of a method described in or related to any of the examples 1-28.

Example 50 includes one or more non-transitory computer-readable media comprising instructions to cause a UE, upon execution of the instructions by one or more processors of the UE, to perform one or more elements of a method described in or related to any of the examples 1-28.

Example 51 includes a UE comprising logic, modules, or circuitry to perform one or more elements of a method described in or related to any of the examples 1-28.

Example 52 includes a UE comprising: one or more processors and one or more computer-readable media comprising instructions that, when executed by the one or more processors, cause the one or more processors to perform one or more elements of a method described in or related to any of the examples 1-28.

Example 53 includes a system comprising means to perform one or more elements of a method described in or related to any of the examples 1-28.

Example 54 includes a network comprising means to perform one or more elements of a method described in or related to any of the examples 29-48.

Example 55 includes one or more non-transitory computer-readable media comprising instructions to cause a network, upon execution of the instructions by one or more processors of the network, to perform one or more elements of a method described in or related to any of the examples 29-48.

Example 56 includes a network comprising logic, modules, or circuitry to perform one or more elements of a method described in or related to any of the examples 29-48.

Example 57 includes a network comprising: one or more processors and one or more computer-readable media comprising instructions that, when executed by the one or more processors, cause the one or more processors to perform one or more elements of a method described in or related to any of the examples 29-48.

Example 58 includes a system comprising means to perform one or more elements of a method described in or related to any of the examples 1-48.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-50. (canceled)

51. An apparatus comprising:
processing circuitry configured to:
perform a measurement on a reference signal, the reference signal received on a beam of a base station; and
generate, for transmission to the base station, of information about the beam based on the measurement, wherein timing of at least one of (i) reception of the reference signal, (ii) performing the measurement, or (iii) the transmission of the information is based on a prediction of a dwelling time in the beam of the base station, wherein the dwelling time represents a time duration during which the beam has a beam quality better than a predefined beam quality or the highest beam quality among beams of the base station; and
interface circuity coupled with the processing circuitry and configured to enable communication.

52. The apparatus of claim 51, wherein the processing circuitry is further configured to:
process configuration information that is received from the base station and that indicates that beam reporting is to be performed; and
process a beam report trigger that is based on the prediction of the dwelling time, wherein the beam report trigger is received from the base station and after the configuration information is received, wherein the prediction of the dwelling time is generated by the base station.

53. The apparatus of claim 52, wherein the processing circuitry is further configured to:
determine a transmission configuration indicator (TCI) state indicated by the configuration information;
generate a first beam report based on the TCI state; and
cause transmission of the first beam report to the base station, wherein the prediction of the dwelling time is generated based on the first beam report.

54. The apparatus of claim 51, wherein the processing circuitry is further configured to:
generate the prediction of the dwelling time; and
cause transmission of the prediction of the dwelling time to the base station, wherein the apparatus is triggered to perform beam reporting based on the prediction of the dwelling time.

55. The apparatus of claim 54, wherein the prediction of the dwelling time includes a predicted beam dwelling time that is quantized by a number of reference signals for a set of current transmission configuration indicator (TCI) states.

56. The apparatus of claim 54, wherein the prediction of the dwelling time is sent as uplink control information (UCI) carried by a physical uplink control channel (PUCCH) or a physical uplink shared channel (PUSCH).

57. The apparatus of claim 54, wherein the processing circuitry is further configured to:
cause transmission, to the base station, of an indication that a beam dwelling time can be predicted over a time interval.

58. The apparatus of claim 51, wherein the processing circuitry is further configured to:
generate the prediction of the dwelling time;
generate, based on the prediction of the dwelling time, a beam report that includes the information about the beam; and
cause transmission of the beam report to the base station absent a trigger from the base station to send the beam report.

59. The apparatus of claim 58, wherein the processing circuitry is further configured to:
process configuration information received from the base station and associated with generating a beam dwelling time prediction and an indication that the beam report is to be generated, wherein the prediction of the dwelling time is performed based on the configuration information; and
generate the beam report based on the prediction of the dwelling time and the indication, wherein the beam report includes the information about the beam.

60. The apparatus of claim 58, wherein the processing circuitry is further configured to:
process configuration information received from the base station and indicating a list of reference signals, wherein the beam report indicates a beam quality for the reference signals and is sent as uplink control information.

61. A method comprising:
generating, for transmission to a user equipment (UE), a reference signal on a beam of a base station; and
processing information that is received from the UE and that is about the beam based a measurement of the reference signal by the UE, wherein timing of at least one of (i) the transmission of the reference signal, (ii) the measurement being performed by the UE, or (iii) reception of the information from the UE is based on a prediction of a dwelling time of the UE in the beam of the base station, wherein the dwelling time represents a time duration during which the beam has a beam quality better than a predefined beam quality or the highest beam quality for the UE among beams of the base station.

62. The method of claim 61 further comprising:
generating, for transmission to the UE, configuration information indicating that the UE is to perform beam reporting; and
generating, for transmission to the UE and after the configuration information is transmitted, a beam report trigger that is based on the prediction of the dwelling time, wherein the prediction of the dwelling time is generated by the base station.

63. The method of claim 62, wherein the configuration information indicates that the UE is to report beam quality for at least a second reference signal that is quasi co-located with a first reference signal indicated in a set of current transmission configuration indicator (TCI) states or that is the same as the first reference signal.

64. The method of claim 62, wherein the beam report trigger corresponds to a trigger a CSI-report having a delay indicated by a media access control (MAC) control element (CE) or downlink control information (DCI).

65. The method of claim 62, wherein the beam report trigger corresponds to a trigger a for a channel state information reference signal (CSI-RS) for beam reporting or to a periodicity of a semi-persistent CSI-RS for beam reporting.

66. The method of claim 61 further comprising:
processing the prediction of the dwelling time received from the UE; and
generating, for transmission to the UE based on the prediction of the dwelling time, a trigger to perform beam reporting.

67. The method of claim 61 further comprising:
processing a beam report that is received from the UE and that includes the information about the beam, wherein the beam report is sent by the UE based on the prediction of the dwelling time and absent a trigger by the base station to the UE to send the beam report.

68. The method of claim 67 further comprising:
generating, for transmission before receiving the beam report, configuration information associated with generating the beam report based on the prediction of the dwelling time.

69. One or more computer-readable storage media storing instructions that, upon execution by one or more processors, cause operations comprising:
processing a reference signal received from a base station on a beam of the base station;
performing a measurement on the reference signal; and
generating, for transmission to the base station, information about the beam based on the measurement, wherein timing of at least one of (i) reception of the reference signal, (ii) performing the measurement, or (iii) the transmission of the information is based on a prediction of a dwelling time in the beam of the base station, wherein the dwelling time represents a time duration during which the beam has a beam quality better than a predefined beam quality or the highest beam quality among beams of the base station.

70. The one or more computer-readable storage media of claim 69, wherein the operations further comprise:
determining the prediction of the dwelling time based on an input to an artificial intelligence model implemented by the UE or the base station, wherein the input includes a past measurement performed on a previously received reference signal on the beam.
